(19) United States
(12) Patent Application Publication
(10) Pub. No.: US 2015/0160149 A1
(43) Pub. Date: Jun. 11, 2015

(54) SENSING MATERIAL FOR GAS SENSOR, GAS SENSOR COMPRISING THE SENSING MATERIAL, METHOD OF PREPARING THE SENSING MATERIAL, AND METHOD OF MANUFACTURING THE GAS SENSOR

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Ji-hyun BAE, Seoul (KR); Jong-jin PARK, Hwaseong-si (KR); Il-doo KIM, Seoul (KR); Byoung-sun LEE, Seoul (KR); Seo-jin LEE, Taebaek-si (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 14/562,831

(22) Filed: Dec. 8, 2014

(30) Foreign Application Priority Data
Dec. 6, 2013 (KR) 10-2013-0151710

(51) Int. Cl. G01N 27/26

(52) U.S. Cl. CPC G01N 27/26

(57) ABSTRACT

A sensing material for a gas sensor, a gas sensor including the sensing material, a method of preparing the sensing material, and a method of manufacturing a gas sensor using the sensing material are provided.

### RELATED APPLICATIONS

This application claims the benefit of Korean Patent Application No. 10-2013-0151710, filed on Dec. 6, 2013, in the Korean Intellectual Property Office, the disclosure of which is incorporated herein in its entirety by reference.

### BACKGROUND

1. Field

The present disclosure relates to a sensing material for a gas sensor, a gas sensor including the sensing material, a method of preparing the sensing material for a gas sensor, and a method of manufacturing a gas sensor using the sensing material.

2. Description of the Related Art

As the conventional use of gas as an energy source has expanded to other areas, use of a gas sensor has been diversified and gas measurements for various purposes have been developed. A conventional gas sensor has been used mainly to detect a toxic or explosive gas. Recently, a variety of technologies for gas sensors have been developed for use in various fields, including health care, surveillance of environmental pollution, industrial safety, home appliances, food and agricultural fields, national defense and prevention of terrorism, and the like.

In particular, research has been conducted to miniaturize and improve the performance, such as sensitivity of gas sensors, and more particularly, to develop a miniature diagnostic sensor using a metal oxide semiconductor. Such a gas sensor using a metal oxide semiconductor detects a gas based on a resistance variation on a surface of the gas sensor resulting from adsorption and desorption of the gas on the surface. For this reason, porous materials including nanoparticles that have a large specific surface area and facilitate gas permeation have drawn attention as sensing materials.

However, preparing such a sensing material having a porous structure involves repetitive complex synthetic and thermal treatment processes. This complex process of preparing the porous sensing material may increase costs, deteriorate the quality of the gas sensor, or increase variations in the quality of the gas sensor.

Therefore, there still is a need for developing a novel sensing material that has improved sensitivity to a target gas and may be easily prepared.

### SUMMARY

Provided are a sensing material for a gas sensor, the sensing material including a Ni₃V₂O₈ nanostructure, a gas sensor that has improved sensitivity characteristics by including the sensing material, a method of easily preparing the sensing material for a gas sensor, and a method of manufacturing a gas sensor using the sensing material.

Additional aspects will be set forth in part in the description which follows and, in part, will be apparent from the description, or may be learned by practice of the presented embodiments.

According to an aspect of the present disclosure, a sensing material for a gas sensor includes a Ni₃V₂O₈ nanostructure.

The Ni₃V₂O₈ nanostructure may have a network structure of nanofibers to which a plurality of nanoparticles are bound.

An average diameter of the nanofibers may be in a range of about 50 nm to about 5000 nm.

The Ni₃V₂O₈ nanostructure may be porous.

The Ni₃V₂O₈ nanostructure may have a resistance that varies with presence and concentration of a gas.

According to another aspect of the present disclosure, a gas sensor includes: a substrate; a first electrode and a second electrode disposed on the substrate; and a sensing layer disposed on the first electrode and the second electrode and including any of the sensing materials described above.

A change in a resistance at a gas concentration of about 10 ppm or less may be measurable.

According to another aspect of the present disclosure, a method of preparing a sensing material for a gas sensor includes: preparing a solution including a Ni₃V₂O₈ precursor, a polymer, and a solvent; preparing a composite of the Ni₃V₂O₈ precursor and the polymer from the solution; and thermally treating the composite to obtain a Ni₃V₂O₈ nanostructure.

### BRIEF DESCRIPTION OF THE DRAWINGS

These and/or other aspects will become apparent and more readily appreciated from the following description of the embodiments, taken in conjunction with the accompanying drawings in which:

FIG. 1 is a scanning electron microscopic (SEM) image of a composite including a Ni₃V₂O₈ precursor and a polymer prepared in Preparation Example 1;

FIG. 2 is a SEM image of Ni₃V₂O₈ nanofibers of Example 1;

FIG. 3 is a transmission electron microscopic (TEM) image of the Ni₃V₂O₈ nanofibers of Example 1;

FIG. 4 is an X-ray diffraction (XRD) spectrum of the Ni₃V₂O₈ nanofibers of Example 1;

FIG. 5 is a schematic view of a gas sensor 10 according to an embodiment of the present disclosure; and

FIG. 6 is a graph illustrating results of evaluating the characteristics of a gas sensor of Example 2.

### DETAILED DESCRIPTION

Reference will now be made in detail to embodiments a sensing material for a gas sensor, a gas sensor including the sensing material, a method of preparing the sensing material, and a method of manufacturing a gas sensor using the sensing material, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. While such terms as “first,” “second,” etc., may be used to describe various components, such components must not be limited to the above terms. The above terms are used only to distinguish one component from another. As used herein, the term “and/or” includes any and all combinations of one or more of the associated listed items. Expressions such as “at least one of,” when preceding a list of elements, modify the entire list of elements and do not modify the individual elements of the list.

According to an embodiment of the present disclosure, a sensing material for a gas sensor includes a Ni₃V₂O₈ nanostructure. The “nanostructure” includes a nano-scale structures containing, for example nanofibers, nanowires, nanoparticles, and/or nanotubes.

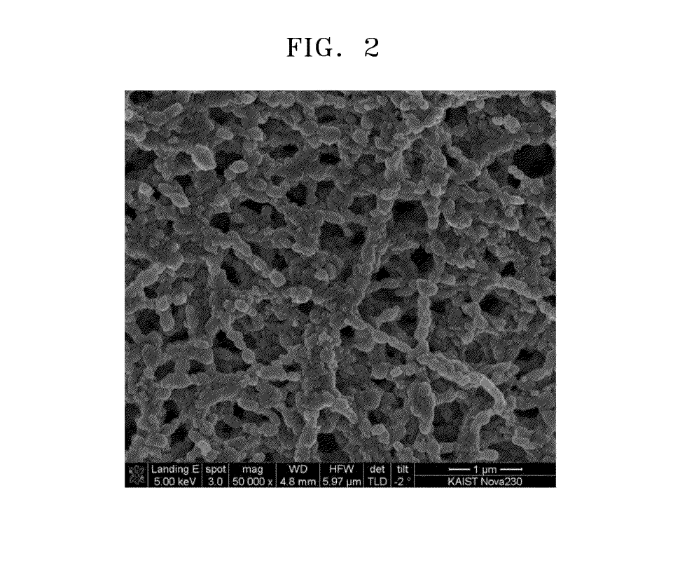

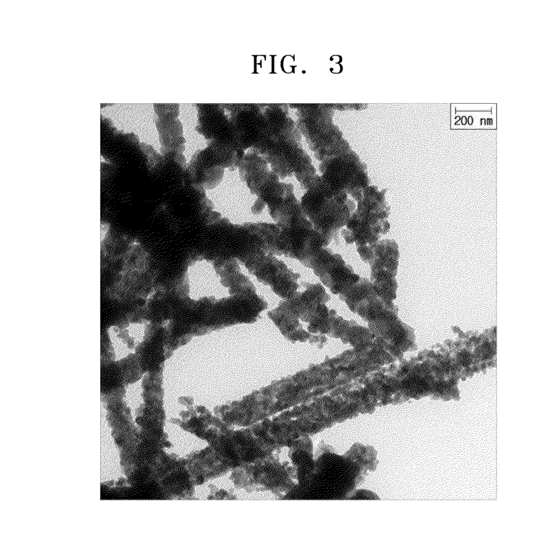

The Ni₃V₂O₈ nanostructure of the sensing material may have a network structure of nanofibers to which a plurality of nanoparticles are bound. Due to the continuous network structure of the sensing material, a gas sensor including the sensing material may be manufactured to have improved reproducibility and electrical stability. This network structure of the Ni₃V₂O₈ nanostructure is presented below with reference to FIGS. 2 and 3.

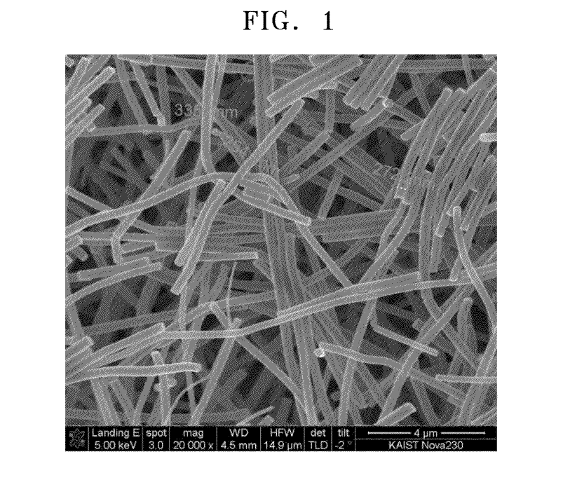

The nanofibers of the Ni₃V₂O₈ nanostructure may have an average diameter of about 50 nm to about 5000 nm. For example, the nanofibers may have an average diameter of about 50 nm to about 3000 nm, in some embodiments, about 50 nm to about 2000 nm, and in some other embodiments, about 50 nm to about 1000 nm. The average diameters of the nanofibers will be presented below with reference to FIG. 1.

The Ni₃V₂O₈ nanostructure of the sensing material may be porous. The Ni₃V₂O₈ nanostructure may include first pores between the nanofibers and second pores between the plurality of nanoparticles. For example, an average size of the first pores may be from about 50 nm to about 500 nm, and an average size of the second pores may be from about 1 nm to 30 nm. In some embodiments, the average size of the first pores may be from about 50 nm to about 300 nm, and the average size of the second pores may be from about 1 nm to about 25 nm. In some other embodiments, the average size of the first pores may be from about 50 nm to about 100 nm, and the average size of the second pores may be from about 1 nm to about 20 nm. When the average sizes of the first and second pores are within these ranges, the porous Ni₃V₂O₈ nanostructure of the sensing material may have a large specific surface area and may facilitate permeation and flow of gas, thereby improving the sensing characteristics of the sensing material. The porous Ni₃V₂O₈ nanostructure will be presented below with reference to FIGS. 2 and 3.

The Ni₃V₂O₈ nanostructure may have a resistance that varies with the presence and concentration of a gas. The sensing material may detect a gas based on a resistance change according to adsorption and desorption of the gas on a surface of the Ni₃V₂O₈ nanostructure.

The gas may include a volatile organic compound gas, an exhalation gas, or an environmental gas. For example, the gas may include at least one selected from benzene, toluene, xylene, ethylbenzene, 1,2-dichloroethane, acetaldehyde, H₂S, acetone, pentane, ethanol, methyl mercaptane, H₂, NH₃, CH₄, dimethyl methylphosphonate (DMMP), phenol, NO_{X}, CO, and SO_{X}, wherein NO_{X} may include nitrogen monoxide (NO), nitrogen dioxide (NO₂), and nitrous oxide (N₂O), and SO_{X} may include sulfur dioxide (SO₂) and sulfur trioxide (SO₃).

In some embodiments, the sensing material for a gas sensor may further include at least one metal oxide selected from SnO₂, ZnO, Fe₂O₃, TiO₂, Fe₂O₃, WO₃, and NiO, or at least one of these metal oxides doped with a transition metal, if needed. Non-limiting examples of the transition metal for doping the metal oxides may include Fe, In, or Ga. The further inclusion of such a metal oxide or a metal oxide doped with such a transition metal may improve a selective detection of target gases in a wider range.

In some other embodiments, the sensing material for a gas sensor may further include a catalyst, if needed. The catalyst may include, for example, platinum (Pt), gold (Au), or silver (Ag). The addition of such a catalyst may further improve the sensitivity characteristics of the sensing material.

According to another embodiment of the present disclosure, a gas sensor includes: a substrate; a first electrode and a second electrode disposed on the substrate; and a sensing layer disposed on the first electrode and the second electrode and including any of the sensing materials according to the above-described embodiments.

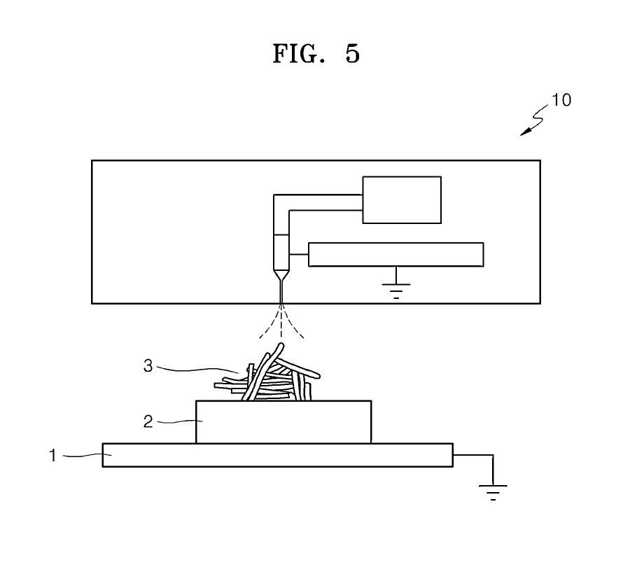

FIG. 5 is a schematic view of a gas sensor 10 according to an embodiment of the present disclosure. Referring to FIG. 5, the gas sensor 10 includes a substrate 1, a first electrode 2 disposed on the substrate 1, and a sensing layer including a Ni₃V₂O₈ nanostructure 3 on the first electrode 2.

The substrate 1 may be a ceramic substrate, a glass substrate, an alumina substrate (Al₂O₃), a plastic substrate, a silicon dioxide (SiO₂) substrate, or a silicon wafer substrate. The substrate 1 may be a substrate including a micro heater for increasing reactivity with gas. A temperature of the micro heater may be externally controlled to further increase the reactivity with gas. In this regard, the substrate 1 may be an alumina substrate (Al₂O₃), a silicon wafer substrate, or a glass substrate. The substrate 1 may have any nonspecific lower electrode structure that ensures manufacture of an interdigitated electrode (IDE) structure, as an array electrode structure, or a parallel-plate structure for detecting a resistance variation.

A first electrode 2 and a second electrode (not shown) may include a metal or metal oxide. The first electrode 2 and the second electrode may be an anode and a cathode, respectively, or vice versa. The first electrode 2 and the second electrode may each be an electrode including at least one selected from platinum (Pt), gold (Au), palladium (Pd), silver (Ag), ruthenium (Ru), nickel (Ni), stainless steel (STS), aluminum (Al), molybdenum (Mo), chromium (Cr), copper (Cu), titanium (Ti), tungsten (W), indium doped tin oxide (ITO, In doped SnO₂), and fluorine doped tin oxide (FTO, F doped SnO₂). For example, the first electrode 2 and the second electrode may be formed as a pattern on the substrate 1.

The sensing layer may be formed by, for example bar coating, drop coating, spray coating, spin coating, doctor blade coating, or sputtering. However, the sensing layer may be formed in other ways too. For example, the sensing layer may be formed by drop coating. Any methods of forming a sensing layer that are available in the art may be used.

The gas sensor 10 may detect a resistance variation at a gas concentration of about 10 ppm or less. For example, the gas sensor 10 may detect a resistance variation at a gas concentration of about 7 ppm or less, and in some embodiments, at a gas concentration of about 5 ppm or less. When a catalyst is further included, such as platinum (Pt), gold (Au), or silver (Ag), the gas sensor 10 may detect a resistance variation even at a gas concentration of 1 ppb or less. A gas detectable with the gas sensor 10 may be the same as that described above in conjunction with the sensing materials according to the above-described embodiments, and thus, a detailed description thereof will be omitted here.

According to another embodiment of the present disclosure, a method of preparing any of the sensing materials for a gas sensor, according to the above-described embodiments, includes: preparing a solution including a Ni₃V₂O₈ precursor, a polymer, and a solvent; preparing a composite of the Ni₃V₂O₈ precursor and the polymer from the solution; and thermally treating the composite to obtain a Ni₃V₂O₈ nanostructure.

Unlike a method of preparing a sensing material using a common metal oxide, the method of preparing a sensing material for a gas sensor, according to the above-described embodiment of the present disclosure, may easily form the Ni₃V₂O₈ nanostructure, without an additional process of thermal compression or thermal pressing. The method of preparing a sensing material for a gas sensor, according to the above-described embodiment, will be described in greater detail below.

First, a solution including a Ni₃V₂O₈ precursor, a polymer, and a solvent may be prepared. The Ni₃V₂O₈ precursor may include, for example, at least one selected from nickel (II) chloride, nickel (II) bromide, nickel (II) carbonate, nickel (II) fluoride, ammonium nickel (II) sulfate, bis(ethylenediamine)nickel (II) chloride, nickel (II) cyclohexanebutyrate, nickel (II) hydroxide, nickel (II) acetate tetrahydrate, ammonium nickel (II) sulfate hexahydrate, nickel (II) bromide hydrate, nickel (II) chloride hexahydrate, vanadium (II) chloride, vanadium (IV) sulfate, vanadium (V) oxychloride, vanadium (V) oxyfluoride, vanadyl sulfate trihydrate (VOSO₄.3H₂O), and vanadyl acetylacetonate. The Ni₃V₂O₈ precursor may be, not limited to the above-listed examples, may be any precursor including a nickel salt and a vanadium salt that may form the Ni₃V₂O₈ nanostructure via a thermal treatment.

An amount of the Ni₃V₂O₈ precursor may be in a range of about 10 wt % to about 40 wt % based on a total weight of the solution. For example, the amount of the Ni₃V₂O₈ precursor may be in a range of about 10 wt % to about 35 wt %, and in some embodiments, in a range of about 10 wt % to about 30 wt %, based on the total weight of the solution. When the amount of the Ni₃V₂O₈ precursor is below these ranges, the Ni₃V₂O₈ nanostructure, for example, Ni₃V₂O₈ nanofibers may be broken during final thermal treatment. On the other hand, when the amount of the Ni₃V₂O₈ precursor is above these ranges, it may be difficult to prepare, for example, Ni₃V₂O₈ nanofibers by electrospinning, or the Ni₃V₂O₈ precursor may be oversaturated to form precipitates in the electrospinning solution.

The polymer may be at least one selected from polyurethane, polyurethane copolymer, cellulose acetate, cellulose, acetate butylate, cellulose derivative, polymethyl methacrylate (PMMA), polymethyl acrylate (PMA), polyacryl copolymer, polyvinylacetate (PVAc) copolymer, polyvinylacetate (PVAc), polyvinylpyrrolidone (PVP), polyvinyl alcohol (PVA), polyfurfuryl alcohol (PFA), polystyrene (PS), polystyrene (PS) copolymer, polyethylene oxide (PEO), polypropyleneoxide (PPO), polyethylene oxide copolymer, polypropyleneoxide copolymer, polycarbonate (PC), polyvinylchloride (PVC), polycaprolactone, polyvinylfluoride, polyvinylidene fluoride copolymer, polyamide, and polyimide. The polymer may be soluble or dispersible in the solvent along with a catalyst precursor, such as a nickel chloride precursor, a nickel acetate precursor, a nickel nitrate precursor, a vanadium acetylacetonate precursor, a vanadium chloride precursor, or a vanadium acetate precursor, depending on a type of the Ni₃V₂O₈ precursor or as needed.

An amount of the polymer may be in a range of about 5 wt % to about 20 wt % based on a total weight of the solution. For example, the amount of the polymer may be in a range of about 5 wt % to about 15 wt % based on the total weight of the solution. When the amount of the polymer is does not fall within these ranges, an electrospinning solution, for example, when the Ni₃V₂O₈ nanostructure is prepared by electrospinning, may not have an appropriate viscosity.

The solvent may be at least one selected from ethanol, water, chloroform, N,N′-dimethylformamide, dimethylsulfoxide, N,N′-dimethylacetamide, and N-methylpyrrolidone. The solvent may be, but is not limited to, any solvent that may dissolve a catalyst precursor, such as a nickel chloride precursor, a nickel acetate precursor, a nickel nitrate precursor, a vanadium acetylacetonate precursor, a vanadium chloride precursor, or a vanadium acetate precursor, depending on a type of the Ni₃V₂O₈ precursor or as needed.

Next, a composite of the Ni₃V₂O₈ precursor and the polymer may be prepared from the solution,

The preparing of the composite of the Ni₃V₂O₈ precursor and the polymer may be performed using electrospinning. In some embodiments, the composite of the Ni₃V₂O₈ precursor and the polymer may be subjected to spinning to form the Ni₃V₂O₈ nanostructure, for example, Ni₃V₂O₈ nanofibers.

Electrospinning is performed by using an electrospinning apparatus including, for example, a spinning nozzle connected to a syringe pump for quantitatively injecting a spinning solution, a high-pressure generator, and a current collector for forming a layer of spun fibers. For example, nanofibers may be prepared by using the current collector as an anode and the spinning nozzle, which is connected to the syringe pump able to regulate a discharge amount of the spinning solution per hour, as a cathode.

For example, in the preparing of the composite of the Ni₃V₂O₈ precursor and the polymer by electrospinning, after filling a syringe with an electrospinning solution including the Ni₃V₂O₈ precursor and the polymer, the electrospinning solution may be slowly discharged at a constant rate by using a syringe pump, and consequently may be spun through the spinning nozzle by electrostatic attraction resulting from an electric field formed between the spinning nozzle and a current collector. During the electrospinning, while the spinning solution is being discharged from the syringe, polymer fibers may be formed in a solid form from the spinning solution along with evaporation of the solvent, and at the same time, polymer fibers may result from intermingling of the Ni₃V₂O₈ precursor and the polymer in an inner core of the solid polymer fibers. As a result of the electrospinning of the solution or dispersion containing the Ni₃V₂O₈ precursor and the polymer, the composite of the Ni₃V₂O₈ precursor and the polymer may be obtained. The polymer may provide viscosity to the solution of the Ni₃V₂O₈ precursor to facilitate electrospinning. In other words, the polymer may serve as a template to retain the shape of nanofibers. The polymer may be decomposed and removed through a subsequent thermal treatment.

Next, the composite of the Ni₃V₂O₈ precursor and the polymer may be thermally treated to obtain the Ni₃V₂O₈ nanostructure.

The thermal treating may be performed at a temperature of about 400° C. to about 800° C. under an atmospheric or oxidation condition. For example, the thermal treating may be performed at a temperature of about 450° C. to about 700° C. under an atmospheric or oxidation condition. The thermal treating may be performed for, for example, about 30 minutes to about 2 hours, while increasing the temperature at a rate of about 5° C./min.

When the thermal treatment temperature of the composite is below these ranges, decomposition of the polymer and oxidation and crystallization of the Ni₃V₂O₈ precursor may be inconsistent, resulting in failure to form a fine network structure of polymer nanofibers. When the thermal treatment temperature of the composite is above these ranges, the fibrous form of the polymer may not be maintained after the thermal treatment or particles of the composite may grow too large to ensure strong mechanical strength of the polymer nanofibers, and consequentially may be decomposed into nanoparticles.

In the thermal treating of the composite to obtain the Ni₃V₂O₈ nanostructure, crystallization of the Ni₃V₂O₈ precursor may occur to form the Ni₃V₂O₈ nanostructure, i.e., porous Ni₃V₂O₈ nanofibers, while the polymer of the composite is thermally decomposed. In other words, salts of the Ni₃V₂O₈ precursor that are uniformly dispersed or dissolved in the composite may undergo uniform nucleation in the fibers through the thermal treatment, thereby forming nanoclusters. The nanoparticles may be interconnected to each other to form polycrystalline Ni₃V₂O₈ nanofibers when the thermal treating is continued for a long time. The Ni₃V₂O₈ precursor may form a polycrystalline phase of Ni₃V₂O₈ nanoparticles since it undergoes the nucleation and crystal growth.

For example, in forming Ni₃V₂O₈ nanofibers by electrospinning, the amounts of the Ni₃V₂O₈ precursor and the polymer, spinning conditions, or thermal treatment conditions may be appropriately controlled to adjust the diameter and inner pore size of the Ni₃V₂O₈ nanofibers. However, the diameter of the nanofibers is not specifically limited.

According to another embodiment of the present disclosure, a method of manufacturing a gas sensor includes: preparing a substrate; forming a first electrode and a second electrode on the substrate; and forming a sensing layer on the first electrode and the second electrode, the sensing layer including any of the sensing material according to the above-described embodiments.

The preparing of the substrate, the forming of the first electrode and the second electrode on the substrate, and the forming of the sensing layer from any of the sensing materials according to the above-described embodiments are according to the embodiments described above with reference to FIG. 5, and detailed descriptions thereof are omitted here.

One or more embodiments of the present disclosure will now be described in detail with reference to the following examples. However, these examples are only for illustrative purposes and are not intended to limit the scope of the one or more embodiments of the present disclosure.

### EXAMPLES

### Preparation of Sensing Material for Gas Sensor

### Preparation Example 1

### Preparation of Composite Including Ni₃V₂O₈ Precursor and Polymer

About 1.0 g of nickel acetate tetrahydrate (nickel (II) acetate tetrahydrate (available from Aldrich) and about 1.0 g of vanadyl acetylacetonate (available from Aldrich), as Ni₃V₂O₈ precursors, were dissolved in about 5 g of N,N′-dimethylformamide to obtain a Ni₃V₂O₈ precursor solution. About 0.7 g of polyvinylpyrrolidone (PVP) polymer were added to the Ni₃V₂O₈ precursor solution and stirred to prepare a spinning solution. After filling a 20-mL syringe with the spinning solution, electrospinning was slowly performed (at a humidity of about 25%, an available voltage of about 14 kV, and an ambient temperature of about 25° C.) while the spinning solution was discharged from the syringe by a syringe pump at a discharge rate of about 0.08 mL/min to vaporize the solvent from the spinning solution, thereby preparing a composite nanofiber of the Ni₃V₂O₈ precursors and the PVP polymer.

### Example 1

### Preparation of Ni₃V₂O₈ Nanofiber

The composite nanofiber of Preparation Example 1, including the Ni₃V₂O₈ precursors and the PVP polymer, were thermally treated at about 500° C. at temperature increase rate of about 5° C./min under an ambient condition for about 1 hour to prepare Ni₃V₂O₈ nanofiber.

(Manufacture of the Gas Sensor)

### Example 2

### Manufacture of the Gas Sensor

A gas sensor having a sensing layer including the Ni₃V₂O₈ nanofiber of Example 1 was manufactured in the following manner.

An alumina (Al₂O₃) substrate having a thickness of about 200 μm was patterned with gold (Au) to form an anode. About 0.4 g of polyvinylacetate (PVAc) having a weight average molecular weight of 500,000 were added to 10 g of dimethylformamide (DMF) to prepare a binder. About 5 mg of the Ni₃V₂O₈ nanofiber of Example 1 were mixed with about 150 μl of the binder and then dispersed using an ultrasonicator for about 30 minutes to prepare a coating solution. The coating solution was coated on the anode by drop coating to form a sensing layer including the Ni₃V₂O₈ nanofiber of Example 1. The substrate including the anode with the sensing layer was thermally treated at about 450° C. for about 30 minutes to manufacture a gas sensor. Then, a micro heater was attached to a bottom surface of the alumina substrate to set a temperature of the gas sensor based on an applied voltage.

(Evaluation of the Shape of the Sensing Material and the Characteristics of the Gas Sensor)

### Evaluation Example 1

### Scanning Electron Microscopic (SEM) and Transmission Electron Microscopic (TEM) Evaluation

The composite of the Ni₃V₂O₈ precursor and the polymer, prepared in Preparation Example 1, and the nanofiber of Example 1 were analyzed by scanning electron microscopy (SEM). The resulting SEM images of the composite of Preparation Example 1 and the nanofiber of Example 1 are shown in FIGS. 1 and 2, respectively.

Referring to FIG. 1, the composite of Preparation Example 1, including the Ni₃V₂O₈ precursor and the polymer, was found to include continuous nanofibers having average diameters of about 254.9 nm, about 272.2 nm, and about 335.4 nm.

Referring to FIG. 2, the Ni₃V₂O₈ nanofiber of Example 1 was found to be polycrystalline and to have a network structure of continuous nanofibers with a plurality of nanoparticles having an average particle diameter of about 1 nm to about 99 nm bound thereto. The average diameter of the Ni₃V₂O₈ nanofiber of Example 1 was found to be slightly reduced, compared to that of the composite of Preparation Example 1 including the Ni₃V₂O₈ precursor and the polymer, due to the thermal treatment during the preparation of the Ni₃V₂O₈ nanofiber of Example 1. The Ni₃V₂O₈ nanofiber of Example 1 was also found to include first pores between the nanofibers and second pores between the plural nanoparticles.

The Ni₃V₂O₈ nanofiber of Example 1 was analyzed by transmission electron microscopy (TEM). The resulting TEM image of the Ni₃V₂O₈ nanofiber of Example 1 is shown in FIG. 3.

Referring to FIG. 3, it is clear that the Ni₃V₂O₈ nanofiber of Example 1 had staphylo-shaped aggregates of plural nanoparticles on surfaces thereof, with first pores between the nanofibers and second pores, relatively smaller than the first pores, between the plural nanoparticles. An average size of the first pores was about 50 nm to about 500 nm, and an average size of the second pores was about 1 nm to about 30 nm.

### Evaluation Example 2

### X-Ray Diffraction (XRD) Analysis

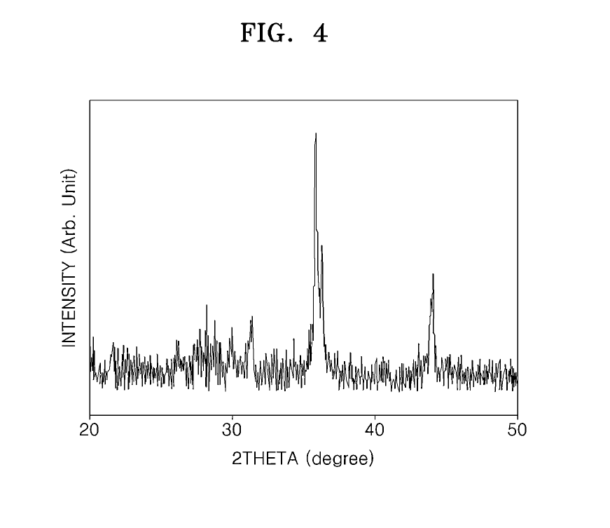

The Ni₃V₂O₈ nanofiber of Example 1 was analyzed by X-ray diffraction (XRD). The results are shown in FIG. 4. Referring to FIG. 4, the Ni₃V₂O₈ nanofiber of Example 1 was found to have a single phase.

### Evaluation Example 3

### Evaluation of the Characteristics of the Gas Sensor

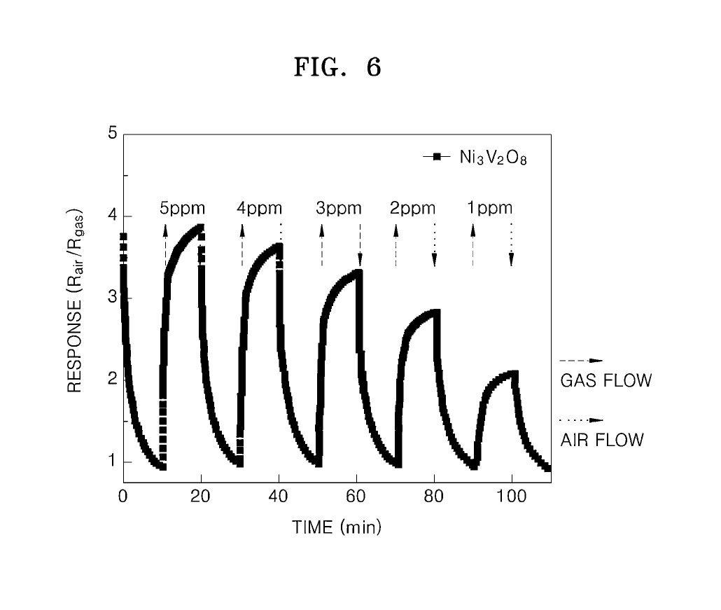

A change in a resistance in the gas sensor of Example 2 at about 350° C. was measured according to an acetone gas concentration change to 5 ppm, 4 ppm, 3 ppm, 2 ppm, and 1 ppm. After a resistance measurement was performed during an injection of the gas for about 10 minutes, air was flowed in to stabilize the gas sensor to an initial status. For the resistance measurement, a humidifier was used to control the humidity to be about 85% to about 95%. A gas supply line for the acetone gas was equipped with a mass flow controller (MSF) to control a flow rate (to about 1,000 sccm), humidity, and a concentration of the gas. The results are shown in FIG. 6.

Referring to FIG. 6, as a result of evaluating the gas sensor of Example 2, the Ni₃V₂O₈ nanofiber of Example 1 in the sensing layer of the gas sensor of Example 2 was found to have n-type semiconductor characteristics. A resistance change in the gas sensor of Example 2 was about 4 times and about 2 times higher at an acetone gas concentration of about 5 ppm and about 1 ppm, respectively, compared to that at a zero concentration level.

As described above, according to the one or more of the above embodiments of the present disclosure, a sensing material for a gas sensor may include a porous Ni₃V₂O₈ semiconductor nanostructure. A gas sensor including the sensing material may have improved sensitivity, thereby being capable of detecting about 10 ppm or less of a gas. A method of easily preparing the sensing material, and a method of manufacturing a gas sensor using the sensing material are also provided.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present disclosure have been described with reference to the attached figures, it will be understood by those of ordinary skill in the art that various changes in form and details may be made therein without departing from the spirit and scope of the present disclosure as defined by the following claims.

What is claimed is:

1. A sensing material comprising Ni₃V₂O₈ nanofibers.

2. The material of claim 1, which further comprises Ni₃V₂O₈ nanoparticles, wherein the Ni₃V₂O₈ nanofibers are in a network structure comprised of the Ni₃V₂O₈ nanofibers and the Ni₃V₂O₈ nanoparticles are bound to the Ni₃V₂O₈ nanofibers.

3. The sensing material of claim 1, wherein an average diameter of the nanofibers is in a range of about 50 nm to about 5000 nm.

4. The sensing material of claim 1, which is porous.

5. The sensing material of claim 2, which comprises first pores between the nanofibers and second pores between the plurality of nanoparticles.

6. The sensing material of claim 5, wherein an average size of the first pores is in a range of about 50 nm to about 500 nm, and an average size of the second pores is in a range of about 1 nm to about 30 nm.

7. The sensing material of claim 1, which has a resistance that varies with presence and concentration of a gas.

8. The sensing material of claim 7, wherein the gas comprises at least one selected from benzene, toluene, xylene, ethylbenzene, 1,2-dichloroethane, acetaldehyde, H₂S, acetone, pentane, ethanol, methyl mercaptane, H₂, NH₃, CH₄, dimethyl methylphosphonate, phenol, NO_{X}, CO, and SO_{X}.

9. A gas sensor comprising:
a substrate;
a first electrode and a second electrode disposed on the substrate; and
a sensing layer disposed on the first electrode and the second electrode, said sensing layer comprising the sensing material of claim 1.

10. The gas sensor of claim 9, wherein the sensing material further comprises Ni₃V₂O₈ nanoparticles, wherein the Ni₃V₂O₈ nanofibers are in a network structure comprised of the Ni₃V₂O₈ nanofibers and the Ni₃V₂O₈ nanoparticles are bound to the Ni₃V₂O₈ nanofibers.

11. The gas sensor of claim 9, wherein the sensing material has first pores of which an average size is in a range of about 50 nm to about 500 nm, and second pores of which an average size is in a range of about 1 nm to about 30 nm

12. The gas sensor of claim 9, wherein the first electrode and the second electrode include a metal or a metal oxide on the substrate.

13. The gas sensor of claim 9, wherein a change in a resistance at a gas concentration of about 10 ppm or less is measurable.

14. A method of preparing a sensing material for a gas sensor, the method comprising:
preparing a solution comprising a Ni₃V₂O₈ precursor, a polymer, and a solvent;
preparing a composite of the Ni₃V₂O₈ precursor and the polymer from the solution; and
thermally treating the composite to obtain a Ni₃V₂O₈ nanostructure.

15. The method of claim 14, wherein the Ni₃V₂O₈ precursor comprises at least one selected from nickel (II) chloride, nickel (II) bromide, nickel (II) carbonate, nickel (II) fluoride, ammonium nickel (II) sulfate, bis(ethylenediamine) nickel (II) chloride, nickel (II) cyclohexanebutyrate, nickel (II) hydroxide, nickel (II) acetate tetrahydrate, ammonium nickel (II) sulfate hexahydrate, nickel (II) bromide hydrate, nickel (II) chloride hexahydrate, vanadium (II) chloride, vanadium (IV) sulfate, vanadium (V) oxychloride, vanadium (V) oxyfluoride, vanadyl sulfate trihydrate (VOSO₄.3H₂O), and vanadyl acetylacetonate.

16. The method of claim 14, wherein an amount of the Ni₃V₂O₈ precursor is in a range of about 10 wt % to about 40 wt % based on a total weight of the solution.

17. The method of claim 14, wherein the polymer comprises at least one selected from polyurethane, polyurethane copolymer, cellulose acetate, cellulose, acetate butylate, cellulose derivative, polymethyl methacrylate, polymethyl acrylate, polyacryl copolymer, polyvinylacetate copolymer, polyvinylacetate, polyvinylpyrrolidone, polyvinyl alcohol, polyfurfuryl alcohol, polystyrene, polystyrene copolymer, polyethylene oxide, polypropyleneoxide, polyethylene oxide copolymer, polypropyleneoxide copolymer, polycarbonate, polyvinylchloride, polycaprolactone, polyvinylfluoride, polyvinylidene fluoride copolymer, polyamide, and polyimide.

18. The method of claim 14, wherein an amount of the polymer is in a range of about 5 wt % to about 20 wt % based on a total weight of the solution.

19. The method of claim 14, wherein the preparing of the composite of the Ni₃V₂O₈ precursor and the polymer is performed using electrospinning.

20. The method of claim 14, wherein the thermal treating is performed at a temperature of about 400° C. to about 800° C. under an atmospheric or oxidation condition.
